(19) United States
(12) Patent Application Publication
(10) Pub. No.: US 2025/0349002 A1
(43) Pub. Date: Nov. 13, 2025

(54) METHODS AND SYSTEMS FOR CLASSIFYING A WHOLE-SLIDE IMAGE

(71) Applicant: The Hong Kong University of Science and Technology, Hong Kong (CN)

(72) Inventors: Hao CHEN, Hong Kong (CN); Renao YAN, Hong Kong (CN); Cheng JIN, Hong Kong (CN)

(21) Appl. No.: 19/194,165

(22) Filed: Apr. 30, 2025

Related U.S. Application Data
(60) Provisional application No. 63/644,511, filed on May 9, 2024.

(51) Int. Cl. G06T 7/00

(52) U.S. Cl. CPC G06T 7/0012; G06T 2207/20081; G06T 2207/30024

(57) ABSTRACT

A computer-implemented method for classifying a whole-slide image (WSI). The method includes: extracting a plurality of instances from a WSI; determining an Instance Importance Score (IIS) for each of the plurality of instances, wherein the IIS is determined based on Shapley Value scoring, and wherein the Shapley Value scoring is based on a contribution of each of the plurality of instances; assigning each of the plurality of instances to one of a plurality of pseudo bags based on the determined IIS; and inputting each of the plurality of instances that are assigned to one of the plurality of pseudo bags to a multiple-instance learning (MIL) classifier.

### CROSS-REFERENCE TO RELATED APPLICATIONS

This application claims priority to, and the benefit of, U.S. Provisional Patent Application Ser. No. 63/644,511 filed May 9, 2024, the disclosure of which is incorporated by reference herein in its entirety.

### FIELD OF INVENTION

The present invention relates broadly, but not exclusively, to methods and systems for classifying a whole-slide image (WSI), and methods and systems for classifying a tissue specimen.

### BACKGROUND

In computational pathology, whole-slide image (WSI) classification presents a formidable challenge due to its gigapixel resolution and limited fine-grained annotations. Multiple-instance learning (MIL) offers a weakly supervised solution, yet refining instance-level information from bag-level labels remains complex. While most conventional MIL methods use attention scores to estimate instance importance scores (IIS) which contribute to the prediction of the slide labels, these often lead to skewed attention distributions and inaccuracies in identifying crucial instances.

Recent advancements in digital pathology and artificial intelligence have significantly expanded the potential for analyzing whole-slide images (WSIs) in diagnostic contexts, prognostic evaluations, and various clinical tasks. A key area within this domain is WSI classification, a fundamental and vital process distinguished by the gigapixel resolution of WSIs, setting it apart from typical natural image classification. The complex nature of the WSI classification task necessitates the adoption of specialized methodologies such as multi-instance learning (MIL). The principle of MIL is that the presence of at least one positive instance within a bag classifies the entire bag as positive; otherwise, it is considered negative. Most of the current research in MIL builds on the essential idea of distilling more instance-level information from bag-level labels. In this paradigm, attention-based pooling stands out as a prominent technique, as the attention score a it generates for each instance in the bag naturally serves as a choice for estimating the contribution of each instance, referred to as the instance importance score (IIS). For example, attention scores play a crucial role in assisting MIL models in discerning significant instances to mitigate overfitting. Moreover, some studies leverage attention scores to fine-tune the feature encoder. The attention score is so influential that these studies all operate under the assumption that crucial (positive) instances can be identified by selecting those with top-ranking attention scores.

However, there are many challenges encountered by attention-based MIL, as illustrated in FIGS. 1(a)-(c), such as:

Extreme distribution of attention: A limited number of instances receive the majority of attention scores. For example, the summation of the top 10 attention scores accounts for 75% or more. This concentration can lead to insufficient training.

Misidentification of positive instances via top-ranking attention scores: Positive instances are not guaranteed to rank at the top. Both positive and negative instances can be filtered out using top-k attention scores. Assigning these instances solely positive labels can introduce noise during training or fine-tuning.

FIGS. 1(a)-(c) show attention distributions and top 5 instances of one example slide in the CAMELYON-16 Dataset. In FIGS. 1(a)-(c), ABMIL, CLAM, DTFD, respectively, are employed. In the column of “Attention Distribution”, the patch index is normalized to a range of 0 to 1 for all patches across all slides in the left sub-figure. Notably, the distribution of attention scores is skewed, with a few instances accumulating a significant share. In the column of “Top 5 Instances”, positive instances (depicted in dashed-line border) are not consistently ranked in order of attention scores, as negative instances (depicted in solid-line border) may take precedence in the queue.

### SUMMARY

According to one embodiment, there is provided a computer-implemented method for classifying a whole-slide image (WSI), including: extracting a plurality of instances from a WSI; determining an Instance Importance Score (IIS) for each of the plurality of instances, wherein the IIS is determined based on Shapley Value scoring, and wherein the Shapley Value scoring is based on a contribution of each of the plurality of instances; assigning each of the plurality of instances to one of a plurality of pseudo bags based on the determined IIS; and inputting each of the plurality of instances that are assigned to one of the plurality of pseudo bags to a multiple-instance learning (MIL) classifier.

According to another embodiment, there is provided a computer-implemented method of classifying a tissue specimen, including: extracting a plurality of instances from a whole-slide image (WSI) of the tissue specimen; and inputting each of the plurality of instances to a multiple-instance learning (MIL) classifier to determine a pathology classification of the tissue specimen. The MIL classifier is trained by a training corpus comprising a training WSI, and wherein training the MIL classifier comprises: extracting a plurality of training instances from the training WSI; determining an Instance Importance Score (IIS) for each of the plurality of training instances, wherein the IIS is determined based on Shapley Value scoring, and wherein the Shapley Value scoring is based on a contribution of each of the plurality of training instances; and assigning each of the plurality of training instances to one of a plurality of pseudo bags based on the determined IIS.

According to another embodiment, there is provided a system for classifying a whole-slide image (WSI), including: a processor module; and a memory module including computer program code. The memory module and the computer program code are configured to, with the processor module, cause the system at least to: extract a plurality of instances from a WSI; determine an Instance Importance Score (IIS) for each of the plurality of instances, wherein the IIS is determined based on Shapley Value scoring, and wherein the Shapley Value scoring is based on a contribution of each of the plurality of instances; assign each of the plurality of instances to one of a plurality of pseudo bags based on the determined IIS; and input each of the plurality of instances that are assigned to one of the plurality of pseudo bags to a multiple-instance learning (MIL) classifier.

According to yet another embodiment, there is provided a system for classifying a tissue specimen, including: a processor module; and a memory module including computer program code. The memory module and the computer program code are configured to, with the processor module, cause the system at least to: extract a plurality of instances from a whole-slide image (WSI) of the tissue specimen; and input each of the plurality of instances to a multiple-instance learning (MIL) classifier to determine a pathology classification of the tissue specimen. The MIL classifier is trained by a training corpus comprising a training WSI, and wherein training the MIL classifier includes: extracting a plurality of training instances from the training WSI; determining an Instance Importance Score (IIS) for each of the plurality of training instances, wherein the IIS is determined based on Shapley Value scoring, and wherein the Shapley Value scoring is based on a contribution of each of the plurality of training instances; and assigning each of the plurality of training instances to one of a plurality of pseudo bags based on the determined IIS.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIGS. 1(a)-(c) show attention distributions and top 5 instances of one example slide in the CAMELYON-16 Dataset.

FIG. 1(d) shows that a PMIL framework, according to an embodiment, achieves a more evenly spread attention distribution compared to ABMIL, CLAM, and DTFD (i.e. FIGS. 1(a)-(c), respectively).

FIGS. 2(a)-(b) illustrates a PMIL framework, according to an embodiment.

FIG. 3 shows bag-level performance results for 5 repeatability experiments on CAMELYON-16, BRACS, and TCGA-LUNG test set.

FIG. 4 shows instance-level performance results for 5 repeatability experiments on CAMELYON-16 test set.

FIG. 5 shows a visualization of pseudo bag assignment using a PMIL framework, according to an embodiment.

FIGS. 6(a)-(c) show heatmaps of 4 slide sub-fields using different models and IIS estimations.

FIG. 7 shows the performance results of pseudo bag augmentation using different IIS measure metrics on CAMELYON-16, BRACS, and TCGA-LUNG test sets.

FIG. 8 shows performance of a model according to an embodiment on the CAMELYON-16 dataset.

FIG. 9 shows repeatability results of various hyper-parameters μ and τ utilized in Shapley value acceleration, according to an embodiment.

FIG. 10 shows evaluation results of pseudo bag augmentation using different progressive strategies on CAMELYON-16, BRACS, and TCGA-LUNG test sets.

FIG. 11 is a flow chart illustrating a computer-implemented method for classifying a whole-slide image (WSI), according to an embodiment.

FIG. 12 is a flow chart illustrating a computer-implemented method of classifying a tissue specimen, according to an embodiment.

FIG. 13 depicts an exemplary computing device/system for executing an embodiment of the disclosed computer-implemented method.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a conventional computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM, GPRS, 3G or 4G mobile telephone systems, as well as other wireless systems such as Bluetooth, ZigBee, Wi-Fi. The computer program when loaded and executed on such a computer effectively results in an apparatus that implements the steps of the preferred method.

The present invention may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC) or Field Programmable Gate Array (FPGA). Numerous other possibilities exist. Those skilled in the art will appreciate that the system can also be implemented as a combination of hardware and software modules.

Embodiments of the invention seek to provide an approach for accurate cancer subtyping from pathological whole-slide images (WSIs) using a multi-instance learning (MIL) framework inspired by cooperative game theory, specifically employing Shapley values to assess the contribution of each instance. Embodiments of the invention seek to enhance the precision of instance importance scores (IIS), crucial for model accuracy, and integrate an attention mechanism to expedite the computation of Shapley values, traditionally a computationally intensive task. This not only speeds up the process but also improves instance identification and prioritization, addressing a major challenge in large-scale medical image analysis. Additionally, embodiments of the invention seek to provide a progressive framework for assigning pseudo bags based on refined IIS, which promotes balanced attention distribution across instances, reducing attention skewness and allowing for the detection of subtle, clinically relevant features.

In computational pathology, whole-slide image (WSI) classification presents a formidable challenge due to its gigapixel resolution and limited fine-grained annotations. Multiple-instance learning (MIL) offers a weakly supervised solution, yet refining instance-level information from bag-level labels remains complex. While most of the conventional MIL methods use attention scores to estimate instance importance scores (IIS) which contribute to the prediction of the slide labels, these often lead to skewed attention distributions and inaccuracies in identifying crucial instances. To address these issues, embodiments of the invention employ Shapley values to assess each instance's contribution, thereby improving IIS estimation. The computation of the Shapley value is then accelerated using attention, meanwhile retaining the enhanced instance identification and prioritization. A framework for progressive assignment of pseudo bags based on estimated IIS is introduced, encouraging more balanced attention distributions in MIL models.

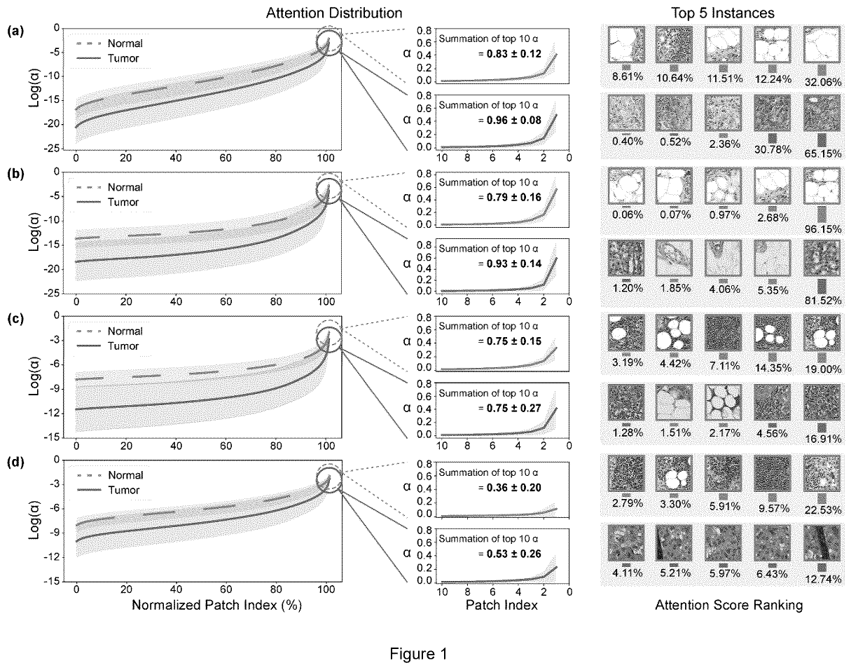

To address inherent problems within attention-based MIL (as described above with reference to FIG. 1(a)-(c)), embodiments of the invention seek to provide a progressive pseudo bag augmented MIL framework, termed PMIL. This framework takes full advantage of pseudo bag augmentation under the guidance of the Shapley value. According to one embodiment, pseudo bag augmentation is first applied to MIL, aiming at encouraging models to focus on more important instances. Furthermore, to improve mis-labelling issues in pseudo bag augmentation, the Shapley value is introduced as a means of IIS estimation to constrain the assignment strategy instead of random splitting. A regular bag is divided into a series of pseudo bags in a reasonable manner, thereby reducing the intrinsic noise associated with pseudo bag creation and enhancing the model's generalization ability.

To address the limitations of attention score-based IIS in terms of ranking accuracy and interpretation, embodiments of the invention introduce an accelerated Shapley value with linear computational complexity to measure IIS in the context of multiple-instance learning.

With Shapley value-based IIS, embodiments of the invention provide a progressive pseudo bag augmented multiple-instance learning framework, effectively bolstering MIL performance.

Extensive experiments on the CAMELYON-16, BRACS, and TCGA-LUNG datasets were performed to demonstrate that embodiments of the invention outperform other state-of-the-art methods in both slide-level and instance-level evaluation, and provide class-wise interpretation with Shapley value-based IIS.

### Shapley Value Approximation

For the sake of conciseness, details on Shapley values will not be described in this specification. In the context of the misidentification of positive instances, the Shapley value offers a solution by quantifying the contribution of each instance based on its interactions with others. Further details can be obtained from: Shapley, Lloyd S, and others. 1953. “A Value for n-Person Games.”; Messalas, Andreas, Yiannis Kanellopoulos, and Christos Makris. 2019. “Model-Agnostic Interpretability with Shapley Values.” In 2019 10th International Conference on Information, Intelligence, Systems and Applications (IISA), 1-7. IEEE; Tang, Siyi, Amirata Ghorbani, Rikiya Yamashita, Sameer Rehman, Jared A Dunnmon, James Zou, and Daniel L Rubin. 2021. “Data Valuation for Medical Imaging Using Shapley Value and Application to a Large-Scale Chest x-Ray Dataset.” Scientific Reports 11 (1): 8366.

In the following description, the MIL paradigm and pseudo bag augmentation techniques will be described. Thereafter, Shapley value-based IIS to improve pseudo bag assignment will be described. Subsequently, a PMIL framework according to embodiments of the invention will be described.

### MIL in WSI classification

In this task, the training set of labeled WSIs is denoted as

$$𝒟 = {\{ {X}_{i} , {Y}_{i} \}}_{i = 1}^{\vert 𝒟 \vert} ,$$

where

$${X}_{i} = {\{ {x}_{i , j} \}}_{j = 1}^{{N}_{i}}$$

represents the i-th bag (slide) comprising Ni instances after feature extraction. The objective is to learn the mapping: [symbol] → [symbol] , where [symbol] is the bag space, and [symbol] is the label space. A conventional MIL classifier maps the aggregated bag-level representation to a prediction as:

$$\hat{{Y}_{ι}} = f ( g ( {\{ {x}_{i , j} \}}_{j = 1}^{{N}_{i}} ) ) , \qquad ( 1 )$$

where g(·) and f(·) represent the aggregator and the fully connected (FC) layer in the MIL classifier, respectively.

### Attention-Based MIL Methods

In attention-based MIL models, the attention score derived from the pooling operation is commonly used to measure IIS. Specifically, the attention score, denoted as α, is calculated for each instance in the bag, providing a measure of its significance in the overall classification decision. Thus, the attention-based aggregation can be expressed as:

$$g ( {\{ {x}_{i , j} \}}_{j = 1}^{{N}_{i}} ) = {\sum }_{j = 1}^{{N}_{i}} {α}_{i , j} \cdot {x}_{i , j} , \qquad ( 2 )$$

where α_{i,j} represents the attention score assigned to the j-th instance in the i-th bag. By incorporating these attention scores, the model not only improves its predictive accuracy but also offers insights into which instances most significantly influence the classification outcome.

### Pseudo Bag Augmentation for MIL

For pseudo bag augmented MIL, a regular bag is randomly split into M pseudo bags, and each pseudo bag inherits the label from its parent bag, resulting in an expanded training set

$${𝒟}^{pse} = {\{ {X}_{i}^{pse} , {Y}_{i} \}}_{i = 1}^{M \times \vert 𝒟 \vert} ,$$

where | [symbol] | is the number of bags.

By obtaining Ŷ^{pse} via Eq. 1, the objective function for pseudo bag augmented MIL is defined:

$$𝒥 ( {𝒟}^{pse} ; θ ) = {\sum }_{i = 1}^{M \times \vert 𝒟 \vert} ℒ ( {\hat{Y}}_{i}^{pse} , {Y}_{i} ) , \qquad ( 3 )$$

where θ represents the parameter of the MIL classifier, and [symbol] represents the cross-entropy loss function. Nevertheless, the label inherited from the parent bag does not always align with the actual label of the pseudo bag. Thus, the objective function in Eq. 3 can be further divided into two parts:

$$𝒥 ( {𝒟}^{pse} ; θ ; ε ) = {\sum }_{i = 1}^{M \times \vert 𝒟 \vert - ε} ℒ ( {\hat{Y}}_{i}^{pse} , {Y}_{i} \vert {Y}_{i} = {Y}_{i}^{pse} ) + {\sum }_{i = 1}^{ε} ℒ ( {\hat{Y}}_{i}^{pse} , {Y}_{i} \vert {Y}_{i} = {Y}_{i}^{pse} ) , \qquad ( 4 )$$

where ε is the number of pseudo bags with incorrectly assigned labels.

Eq. 4 reveals a trade-off between bolstering the diversity of instances and introducing extra noise. It should be highlighted that existing MIL methods employ a strategy of randomly splitting bags into pseudo bags, leading to suboptimal outcomes.

### Shapley Value-Based IIS Estimation

It can be seen from FIGS. 1(a)-(c) that a might not accurately reflect the ranking of importance. Thus, embodiments of the invention introduce the Shapley value ϕ as an alternative method in contrast to the attention score to estimate IIS:

$${ϕ}_{i , j} ( {x}_{i , j} , {X}_{i} \backslash \{ {x}_{i , j} \} ) {=}^{Δ} {\sum }_{{S}_{i} ⊆ {X}_{i} \backslash \{ {x}_{i , j} \}} \frac{\vert {S}_{i} \vert ! ( \vert {X}_{i} \vert - \vert {S}_{i} \vert - 1 ) !}{\vert {X}_{i} \vert !} \times [ f ( g ( {S}_{i} ⋃ \{ {x}_{i , j} \} ) ) - f ( g ( {S}_{i} ) ) ] , \qquad ( 5 )$$

where x_{i,j} is the j-th feature in the i-th bag to calculate the Shapley value ϕ_{i,j}, Xᵢ is the full feature set of the i-th bag, sᵢ⊆Xᵢ\{x_{i,j}} are all available subsets.

Upon scrutinizing Eq. 5, the computational complexity of the original Shapley value formulation escalates exponentially with the number of instances, which is prohibitively time-intensive in WSI classification as each bag encompasses thousands of instances. To hasten this process, several methodologies have been developed to approximate Shapley values effectively. Notably, according to the principle of MIL, it is the positive instances that determine the bag label. Under this premise, embodiments of the invention leave the less significant instances in the order of attention scores, and focus on rearranging the importance ranking of instances with high attention scores by their Shapley value-based IIS:

$$IIS ( {x}_{i , j} ) = {ϕ}_{i , j} ( {x}_{i , j} , {S}_{i}^{l} ) , {x}_{i , j} ∈ {S}_{i}^{h} , \qquad ( 6 )$$

where

$${S}_{i}^{h} and {S}_{i}^{l} = {X}_{i} - {S}_{i}^{h}$$

denote the instance subset with high and low attention scores, and Xᵢ is the universal set of all instances.

For the sake of simplicity, the instance number in

$${S}_{i}^{h}$$

is set to μM, and the sampling number for

$${S}_{i}^{l}$$

is set to τ. Under the assumption that the reasoning time per bag for the model approximates a constant γ, it is possible to quantify the computational complexity of different IIS estimations:

$$Ω ( α ) = {\sum }_{i = 1}^{\vert 𝒟 \vert} γ = γ \vert 𝒟 \vert , \qquad ( 7 )$$

$$Ω ( ϕ ( x , X \backslash \{ x \} ) ) = {\sum }_{i = 1}^{\vert 𝒟 \vert} {\sum }_{j = 0}^{{N}_{i}} {C}_{{N}_{i}}^{j} \cdot γ = γ {\sum }_{i = 1}^{\vert 𝒟 \vert} {2}^{{N}_{i}} , \qquad ( 8 )$$

$$Ω ( ϕ ( x , {S}^{l} ) ) = {\sum }_{i = 1}^{\vert {S}_{i}^{h} \vert} {\sum }_{j = 0}^{τ} γ = γτμ M , \qquad ( 9 )$$

where Ω is the asymptotic lower bond of the computational complexity, and

$${C}_{{N}_{i}}^{j}$$

is the combination value. Derived from Eq. 5, the calculation of the Shapley value involves exponential computational complexity, while that of the attention score exhibits linear complexity. By employing an approximation technique, embodiments of the invention transform the Shapley-based IIS computation into a linear complexity as depicted in Eq. 9, while ensuring its ranking accuracy remains intact within the realm of multiple-instance learning.

### IIS-Based Pseudo Bag Augmentation

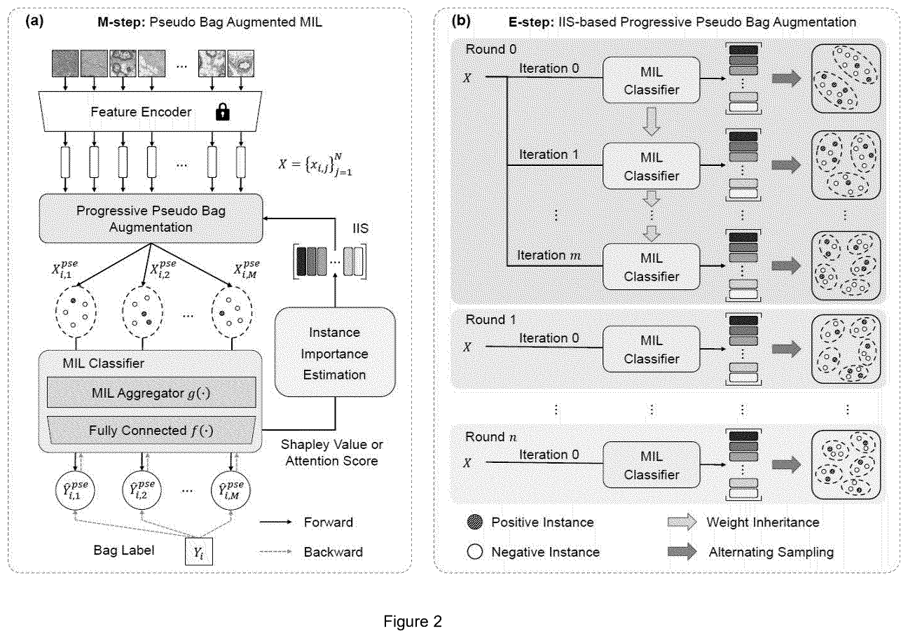

As illustrated in FIG. 2(b), instances within each bag are rearranged according to the ranking of IIS, denoted as

$${X}_{i}^{′} = \{ {x}_{i , j}^{′} \vert IIS ( {x}_{i , 1}^{′} ) \geq IIS ( {x}_{i , 2}^{′} ) \geq … \geq IIS ( {x}_{i , {N}_{i}}^{′} ) \} .$$

These instances are evenly interleaved into M pseudo bags by using the modulo function mod to constrain

$${x}_{i , j}^{′}$$

to satisfy j≡k (mod M), resulting in that each pseudo bag

$${X}_{i , k}^{pse}$$

denotes as a sample from

$${X}_{i}^{′} .$$

By fixing the parameter θ of MIL models, the optimization of ε can be approximated as:

$$\begin{matrix}{ε}^{*} = min \sum ( {\hat{Y}}_{i} \neq {Y}_{i}^{pse} ) = max \sum ( {\hat{Y}}_{i} \neq {Y}_{i}^{pse} ) \\ ⇔ {min}_{{X}^{′}} {D}_{KL} ( {P}_{{X}^{pse} \sim Γ ( {X}^{′} )} [ {Y}^{pse} \vert {X}^{pse} ; θ ] ‖ P [ Y \vert X ; θ ] ) ,\end{matrix} \qquad ( 10 )$$

where Γ(X′) is the instance importance distribution of X′ with estimated IIS and D_{KL} is Kullback-Leibler divergence function. Thus, the optimization of ε is translated to that of Γ(X′), where the IIS estimation plays a decisive role.

Furthermore, it is important to consider progressive strategies concerning the quantity and initialization of pseudo bags. Splitting a regular bag into a large number of pseudo bags can introduce excessive noise, which may lead to training instability, particularly when regular bags contain only a limited number of positive instances. To address this issue, embodiments of the invention progressively increase the number of pseudo bags once the MIL model converges during training:

$$\begin{matrix}{M}_{t} = min \{ {M}_{t - 1} + Δ M , {M}_{max} \} , \\ s . t . \{ {g}_{t - 1} , {f}_{t - 1} \} \to ( {g}_{t - 1}^{*} , {f}_{t - 1}^{*} \} ,\end{matrix} \qquad ( 11 )$$

where t signifies the convergence iteration, ΔM denotes the increment in the number of pseudo bags, and M₀ and Mₘₐₓ represent the initial and maximum numbers of pseudo bags, respectively. In addition, the initial assignment of pseudo bags significantly influences subsequent training, especially when dealing with challenging datasets. To address this issue, embodiments of the invention gradually leverage the well-trained MIL model from the previous round to enhance the initial pseudo bag augmentation by calculating instance importance scores.

### Progressive Pseudo Bag Augmented MIL

Under the guidance of IIS estimated by Shapley values (instead of attention scores used in the existing architectures), embodiments of the invention seek to provide a progressive pseudo bag augmented MIL framework (termed “PMIL”). To alleviate the mislabeling issue in Eq. 4, embodiments of the invention incorporate an expectation-maximization (EM) algorithm to obtain optimal pseudo bag label assignment. Specifically, the parameter θ of the MIL model can be learned via Eq. 3 as the M-step, and the minimization problem for ε is translated into an assignment optimization for pseudo bags via Eq. 10 as the E-step. As illustrated in FIG. 2(b), this iterative optimization is implemented within n training rounds.

As illustrated in FIG. 2 illustrates the PMIL framework. In FIG. 2(a), a collection of patches, extracted from a WSI, is partitioned into M (M gradually increases) pseudo bags based on their estimated IIS, and then are trained in the same manner as regular bags. In FIG. 2(b), the weights of the MIL model are frozen to estimate IIS, facilitating pseudo bag assignment. The number M of pseudo bags progressively increases at the iteration when the MIL model converges in round 0, and initial pseudo bags are assigned using IIS estimated by the MIL model in the previous round. The pseudo bag augmentation is only used during the training process (i.e. both the E-step and the M-step).

### Experiments

The following section provides details on evaluation of embodiments of the invention.

### Datasets and Evaluation Metrics

The experimental setup employs three publicly available datasets to assess the performance of embodiments of the invention.
CAMELYON-16 focuses on detecting lymph node metastasis in early-stage breast cancer. It comprises 399 WSIs, with 270 allocated for training and 129 for testing. The official training set follows a 5-fold cross-validation protocol to generate training and validation sets. Furthermore, a total of 337,124 negative instances and 60,077 positive instances are assigned instance labels based on the annotations in the test set for subsequent evaluation.
BRACS is curated for breast cancer subtyping and contains 547 WSIs. The classification task involves benign tumors, atypical tumors (AT), and malignant tumors (MT). The official dataset split is followed, with 395 for training, 65 for validating, and 87 for testing. Five separate experiments were conducted with different random seeds.
TCGA-LUNG comprises 1034 WSIs, encompassing 528 lung adenocarcinoma (LUAD) and 506 lung squamous cell carcinoma (LUSC) cases. A 5-fold cross-validation protocol was adopted for both training and testing.

The following multi-class evaluation metrics are used for bag-level evaluation: slide-level accuracy (ACC), one-versus-rest area under the curve (AUC), and macro F1 score. The following binary evaluation metrics are used for instance-level evaluation: ACC, AUC, F1 score, precision, and recall.

### Implementation Details of Evaluation

In the preprocessing stage, OTSU's thresholding method is used to detect and localize tissue regions for patch generation. Non-overlapping patches measuring 256×256 pixels are created at magnifications of 20× for CAMELYON-16 and TCGA-LUNG, and 5× for BRACS. This process results in an average of approximately 7156, 11951, and 714 patches per bag for these datasets, respectively.

All experiments were performed on a workstation equipped with NVIDIA RTX 3090 GPUs. ResNet50 was employed as the encoder and ABMIL as the primary MIL model. The Adam optimizer, with a weight decay of 1e−5, was selected. An early stopping strategy was implemented, setting the patience parameter to 20 epochs. The initial learning rate was established at 3e−4 and subsequently reduced to 1e−4 for fine-tuning purposes. For the CAMELYON-16 dataset, the maximum number of pseudo bags was limited to 8; for BRACS, the limit was 10; and for TCGA-LUNG, it was 14. The increment in the number of pseudo bags is set to 4. In terms of Shapley value computation acceleration, the parameter μ was set to 10 and τ to 3. The total EM training round n is set to 10.

### Evaluation and Comparison

The experimental results of the PMIL framework built on the ABMIL backbone for CAMELYON-16, BRACS, and TCGA-LUNG datasets will be presented, comparing them with the following methods: (1) Conventional instance-level MIL, including the Mean-Pooling MIL and Max-Pooling MIL. (2) The vanilla attention-based MIL, ABMIL (Ilse, Tomczak, and Welling 2018). (3) Two variants of ABMIL, including non-local attention pooling DSMIL (B. Li, Li, and Eliceiri 2021), single-attention-branch CLAM-SB (Lu et al. 2021). (4) transformer-based MIL, TransMIL (Z. Shao et al. 2021). (5) Pseudo bag augmented MIL, DTFD (H. Zhang et al. 2022).

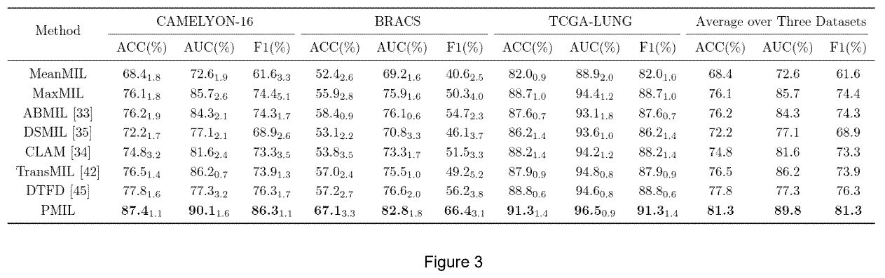

FIG. 3 shows bag-level performance results for 5 repeatability experiments on CAMELYON-16, BRACS, and TCGA-LUNG test set. The subscripts are the standard deviation of each metric. The best evaluation results are in bold.

In the bag-level evaluation, as shown in FIG. 3, the PMIL framework according to embodiments of the invention demonstrates remarkable performance, achieving AUC scores of 90.1% for CAMELYON-16, 82.8% for BRACS, and 96.5% for TCGA-LUNG. These scores consistently exceed those of all other methods included in the comparison. Notably, on the complex BRACS dataset, embodiments of the invention exhibit significant superiority. The generation of progressively refined pseudo bags contributes to enhanced training diversity and a reduction in the number of instances per bag. This strategy effectively improves the proficiency of the model in learning from positive instances.

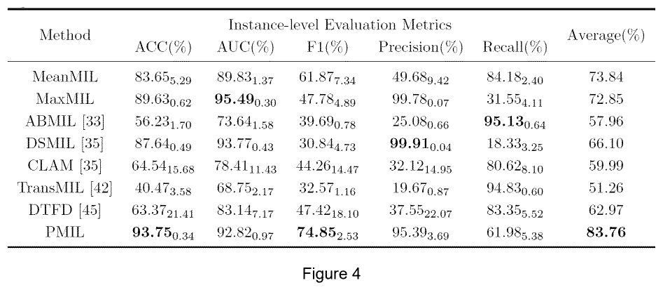

FIG. 4 shows instance-level performance results for 5 repeatability experiments on CAMELYON-16 test set. The subscripts are the standard deviation of each metric. The best evaluation results are in bold.

In the instance-level evaluation, as illustrated in FIG. 4, certain methods, such as MaxMIL and DSMIL, exhibited high precision scores but low recall scores, indicating a cautious tendency towards predicting positive instances. Conversely, methods like MeanMIL, ABMIL, CLAM, TransMIL, and DTFD displayed the opposite trend, often predicting a larger number of instances with positive labels, albeit less precisely. In contrast, embodiments of the invention provided significantly more precise predictions for positive instances and outperformed other methods in terms of both ACC and F1 score.

### Visualization and Interpretation

To assess the effectiveness of progressive pseudo bag augmentation in shifting the network's focus toward more positive instances, the attention distribution of embodiments of the invention was analyzed. FIG. 1(d) shows that PMIL achieves a more evenly spread attention distribution compared to ABMIL, CLAM, and DTFD (i.e. FIGS. 1(a)-(c), respectively). Additionally, the total of the top 10 attention scores is reduced to 0.36 in normal cases and to 0.53 in tumor cases.

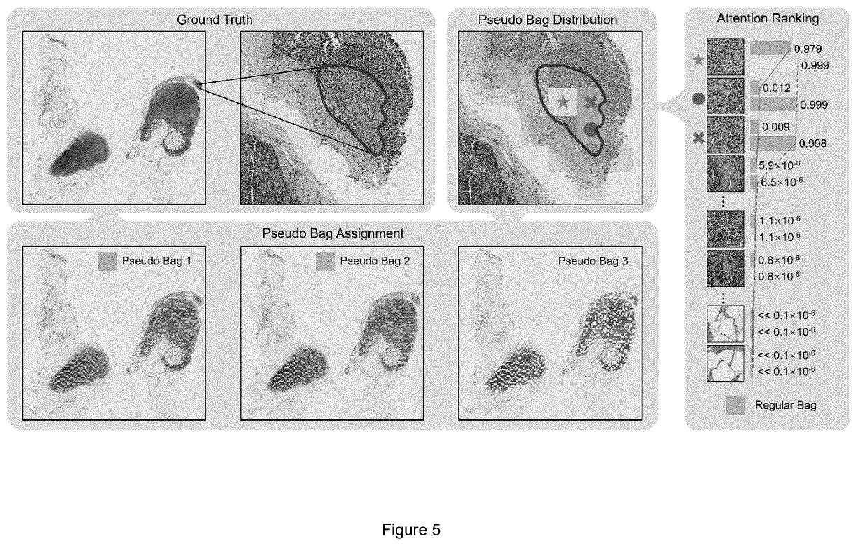

A specific instance of pseudo bag assignment in PMIL is depicted in FIG. 5. Specifically, FIG. 5 shows the visualization of pseudo bag assignment using PMIL. The annotated region represents cancer regions. Embodiments of the invention can locate only three positive instances (denoted by the “star”, “circle” and “cross” symbols) even in the micro-metastasis case based on the ranking of Shapley values, and split them into pseudo bags evenly. The attention ranking reveals that more positive instances are noticed during training by accurate pseudo bag augmentation.

As shown in FIG. 5, in the case of micro-metastasis, PMIL successfully identifies three crucial patches. The random partitioning approach only has a chance with a rate of 2/9 to accurately allocate positive instances across three different pseudo bags, which could otherwise contribute noise to the training. In contrast, embodiments of the invention confidently place these patches into different pseudo bags, significantly increasing the diversity of positive instances.

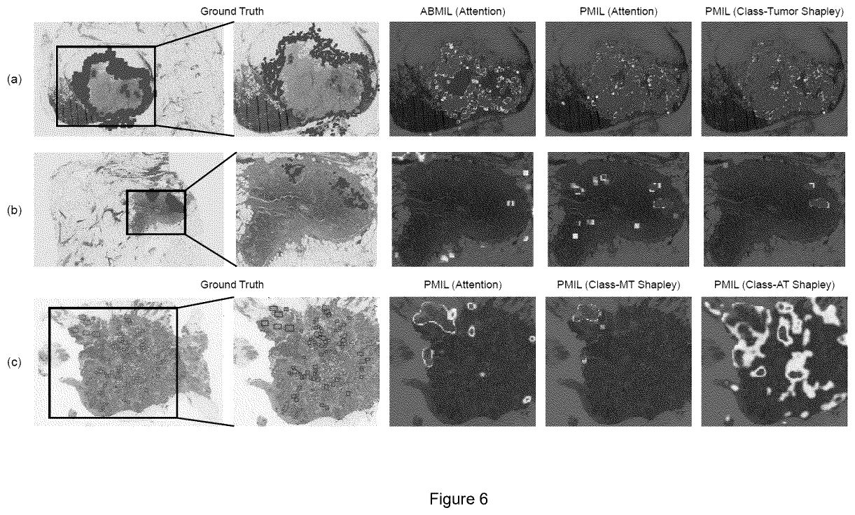

To emphasize the limitations of the attention score-based IIS, a comparative analysis was conducted, as illustrated in FIGS. 6(a) and (b). In cases of macro metastasis, both ABMIL and PMIL show effective performance. However, in micro metastasis scenarios, the attention score-based IIS suggests that both ABMIL and PMIL erroneously focus on some noncancerous areas, which eludes logical interpretation. Conversely, using Shapley value-based IIS, PMIL precisely excludes noncancerous regions and accurately pinpoints cancerous areas.

In more detail, FIG. 6 shows heatmaps of 4 slide sub-fields using different models and IIS estimations. FIGS. 6(a) and (b) are macro and micro metastasis cases from CAMELYON-16, where relatively darker regions are cancer regions and relatively lighter regions are noncancer regions in the column of ‘Ground Truth’. FIG. 6(c) is the malignant tumor case from BRACS, where relatively darker rectangular regions are the malignant tumor (MT) regions and relatively lighter boxed regions are atypical tumor (AT) regions in the column of ‘Ground Truth’. In other columns, relatively lighter shaded indicate higher probabilities.

Distinct from attention scores, the computation of Shapley values encompasses the entire MIL classifier, incorporating diverse category information, thereby enabling interpretations on a class-wise basis. As shown in FIG. 6(c), the IIS estimated by attention scores and class-MT Shapley values predominantly focus on malignant tumor regions. Meanwhile, the heatmaps generated using class-AT Shapley values predominantly emphasize atypical tumor regions, aligning with the slide-level labels. Although the heatmaps might not be entirely accurate for the BRACS dataset, this finding highlights the robust interpretability of Shapley value-based IIS in multiple classification tasks.

In summary, the visualization results indicate that while attention score-based IIS often produces a noisy ranking of instance importance and is limited to a single target category, Shapley value-based IIS ensures a more accurate ranking of instance importance and enables class-wise interpretations, leveraging the full capacity of the MIL classifier.

### Ablation Study

### IIS Measure Estimation Metrics

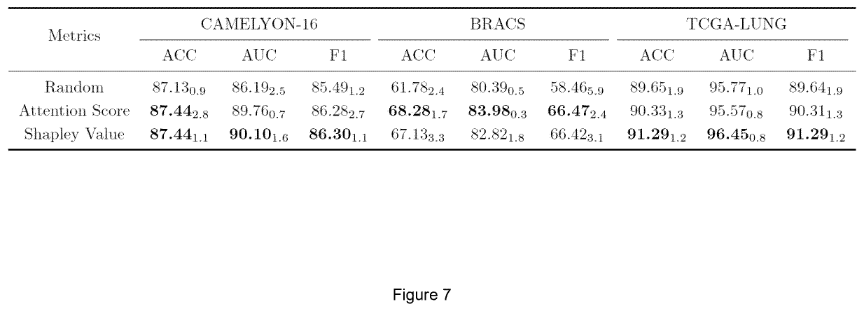

In ablation studies, both the attention score and the Shapley value were evaluated as methods for estimating IIS for subsequent training, using random splitting as the baseline for pseudo bag augmentation. According to the results presented in FIG. 7, Shapley value-based IIS estimation demonstrates superior performance on the CAMELYON-16 and TCGA-LUNG datasets. Conversely, on the BRACS dataset, the attention score-based estimation yielded better results. This variation in effectiveness is likely due to the direct acquisition of attention scores via pooling operations. In contrast, calculating the Shapley value requires an additional fully connected layer, which may be less robust when the overall performance of the MIL classifier is not particularly high. Therefore, the Shapley value estimation is more advantageous with datasets that pose fewer learning challenges.

In particular, FIG. 7 shows the performance results of pseudo bag augmentation using different IIS measure metrics on CAMELYON-16, BRACS, and TCGA-LUNG test sets. The subscripts are the standard deviation. The best evaluation results are in bold.

### Sensitivity to Hyper-Parameters

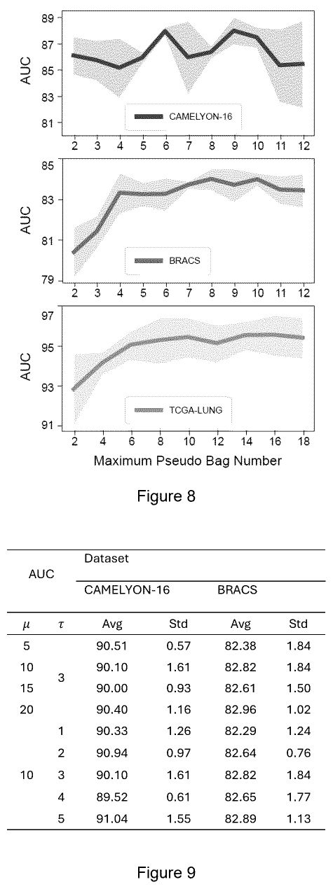

The optimal number of pseudo bags, Mₘₐₓ, varies across datasets due to differences in magnification levels of the patches and the sizes of tumor regions. As depicted in FIG. 8, on the CAMELYON-16 dataset, a model according to an embodiment of the invention exhibits peak performance with an Mₘₐₓ of approximately 9, experiencing a sharp decline in effectiveness when Mₘₐₓ exceeds this value. Similarly, the ideal Mₘₐₓ or the BRACS and TCGA-LUNG datasets is found to be 10 and 14, respectively. The smaller Mₘₐₓ on CAMELYON-16 can be attributed to the prevalence of micro metastasis slides containing few positive instances, even at a 20× magnification. In such scenarios, pseudo bag augmentation must balance between introducing additional noise to the training set and enhancing training diversity. Conversely, the larger cancer (subtype) regions in the BRACS and TCGA-LUNG datasets allow for division into more pseudo bags without compromising stability.

FIG. 9 shows the repeatability results of various hyper-parameters μ and τ utilized in Shapley value acceleration. FIG. 9 shows that the performance of embodiments of the invention is not significantly affected by changes in μ and τ, as the performance fluctuations fall within an acceptable range.

### Progressive Pseudo Bag Augmentation

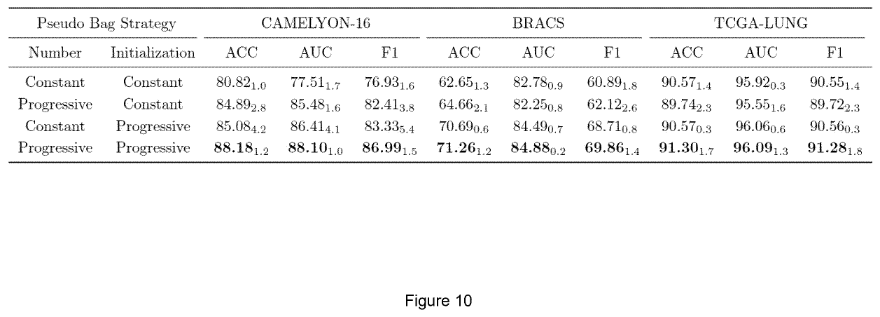

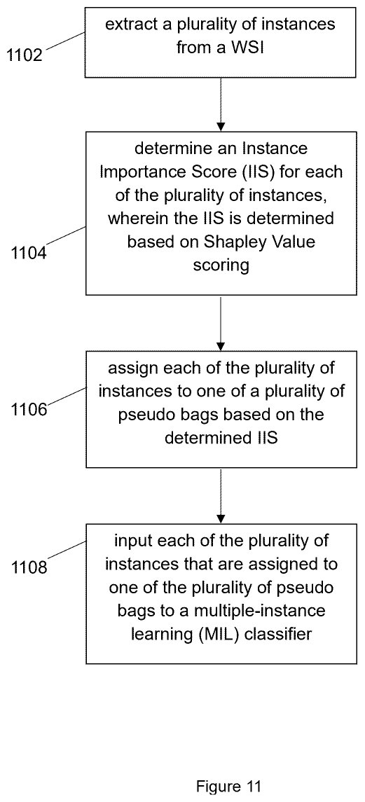

To ascertain the efficacy of progressively increasing the pseudo bag count and refining the initial pseudo bag assignment, a series of experiments were carried out. The pseudo bag increment AM was set to 4, with the training rounds, n as 5 for the CAMELYON-16 and TCGA-LUNG datasets, and extended to 10 for the more intricate BRACS dataset. The results, as indicated in FIG. 10, show that models incorporating both progressive tactics achieve the highest levels of performance. The CAMELYON-16 dataset is particularly sensitive to the number of pseudo bags, necessitating precise calibration to prevent the introduction of undue noise. Conversely, the BRACS dataset's sensitivity lies in the initial setup of pseudo bags, owing to the challenge of distinguishing between subtypes. A more sophisticated initial setup significantly aids the model in accurately recognizing positive instances, leading to enhanced performance.

In particular, FIG. 10 shows the evaluation results of pseudo bag augmentation using different progressive strategies on CAMELYON-16, BRACS, and TCGA-LUNG test sets. The subscripts are the standard deviation. The best evaluation results are in bold.

From the ablation studies, several key insights are as follows:
Selection of IIS Estimation Metrics. The selection of IIS estimation methods depends on the characteristics of the dataset. While attention score-based IIS is commonly employed, its ranking accuracy can sometimes be compromised. In contrast, Shapley value-based IIS tends to show improved performance in less complex datasets as its effectiveness largely relies on precise classification outcomes.
Sensitivity to Hyper-parameters. The optimal maximum pseudo bag number Mₘₐₓ varies across datasets and heavily relies on the number of positive instances present. For datasets containing larger tumor regions within bags, a higher Mₘₐₓ is recommended. Conversely, datasets with fewer positive instances per bag benefit from a smaller Mₘₐₓ to avoid unnecessary complexity. Embodiments of the invention exhibit insensitivity to hyper-parameters used in Shapley value approximation. Nevertheless, it is advisable not to set μ and τ too small.
Progressive Strategies. A progressive increase in the number of pseudo bags is effective for challenging datasets or those with only a limited number of positive instances in each bag. While this approach is less appealing for datasets with substantial tumor regions. Conversely, progressive initialization represents a significant improvement across various datasets, especially on more challenging ones.

In summary, embodiments of the invention seek to tackle attention-related challenges within multiple-instance learning for whole-slide image classification, particularly the extreme distribution of attention and misidentification of positive instances. To overcome these challenges, embodiments of the invention introduce accelerated Shapley value, which quantifies the contribution of each instance, to estimate IIS. This approach facilitates a more logical allocation of pseudo bags.

Furthermore, embodiments of the invention provide a progressive pseudo bag augmented multiple-instance learning framework that incorporates Shapley value-based IIS and utilizes the expectation-maximization algorithm. This approach systematically improves pseudo bag augmentation, thus significantly enhancing the efficacy of MIL.

Extensive experiments on three publicly available datasets demonstrate that the performance of embodiments of the invention surpass existing state-of-the-art techniques. Additionally, the Shapley value-based IIS offers valuable class-wise interpretability for pathological whole-slide images.

FIG. 11 is a flow chart illustrating a computer-implemented method for classifying a whole-slide image (WSI), according to an embodiment. Step 1102 involves extracting a plurality of instances from a WSI. In this disclosure, the term “patch(es)” may be used interchangeably with “instance(s)”.

Step 1104 involves determining an Instance Importance Score (IIS) for each of the plurality of instances. The IIS is determined based on Shapley Value scoring. The Shapley Value scoring is based on a contribution of each of the plurality of instances. In other words, each instance has its own IIS. Each instance contributes to computing the bag-level label. The Shapley value provides a quantitative measure of contribution assessment. The Shapley Value scoring has been described in detail above.

Step 1106 involves assigning each of the plurality of instances to one of a plurality of pseudo bags based on the determined IIS. In other words, each instance is assigned/split into one of the pseudo bags. Further, the assigning/splitting depends on the IIS of the particular instance.

Step 1108 involves inputting each of the plurality of instances that are assigned to one of the plurality of pseudo bags to a multiple-instance learning (MIL) classifier.

Step 1106 of assigning each of the plurality of instances to one of the plurality of pseudo bags based on the determined IIS may include: (i) ranking each of the plurality of instances based on the determined IIS; and (ii) evenly interleaving each of the plurality of instances into one of the plurality of pseudo bags based on the rank of each of the plurality of instances.

An example of evenly interleaving is as follows: Assume that there are 10 instances, ranked from 1 to 10. Further, assume that there are 3 pseudo bags (A, B and C). Pseudo bag A may have instances that are ranked 1, 4, 7 and 10. Pseudo bag B may have instances that are ranked 2, 5 and 8. Pseudo bag C may have instances that are ranked 3, 6 and 9.

The computer-implemented method for classifying a WSI may further include increasing a number of the plurality of pseudo bags during a subsequent training iteration on a condition that the MIL classifier converges.

The computer-implemented method for classifying a WSI may further include freezing the weights of the MIL classifier when determining the IIS for each of the plurality of instances.

The above-described computer-implemented method for classifying a WSI as illustrated in FIG. 11 is generally directed to training of the MIL classifier.

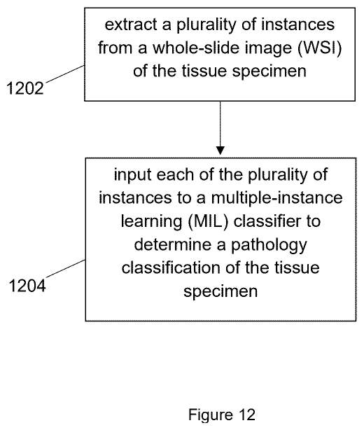

FIG. 12 is a flow chart illustrating a computer-implemented method of classifying a tissue specimen, according to an embodiment. Step 1202 involves extracting a plurality of instances from a whole-slide image (WSI) of the tissue specimen. The digital WSI may be provided by hospitals or institutions. In other words, optionally, before step 1202, the method of classifying a tissue specimen may include receiving or obtaining a WSI of the tissue specimen.

Step 1204 involves inputting each of the plurality of instances to a multiple-instance learning (MIL) classifier to determine a pathology classification of the tissue specimen.

The MIL classifier is trained by a training corpus comprising a training WSI. The training of the MIL classifier may be based on the steps mentioned above, e.g. with reference at least to FIG. 11. For example, the training may include extracting a plurality of training instances from the training WSI, and determining an Instance Importance Score (IIS) for each of the plurality of training instances. The IIS is determined based on Shapley Value scoring. The Shapley Value scoring is based on a contribution of each of the plurality of training instances. The training may further include assigning each of the plurality of training instances to one of a plurality of pseudo bags based on the determined IIS.

The above-described computer-implemented method of classifying a tissue specimen as illustrated in FIG. 12 is generally directed to clinical diagnosis and digital pathology.

According to an embodiment, there is provided a system for classifying a whole-slide image (WSI). The system includes a processor module and a memory module including computer program code. The memory module and the computer program code are configured to, with the processor module, cause the system at least to: (i) extract a plurality of instances from a WSI; (ii) determine an Instance Importance Score (IIS) for each of the plurality of instances, wherein the IIS is determined based on Shapley Value scoring, and wherein the Shapley Value scoring is based on a contribution of each of the plurality of instances; (iii) assign each of the plurality of instances to one of a plurality of pseudo bags based on the determined IIS; and (iv) input each of the plurality of instances that are assigned to one of the plurality of pseudo bags to a multiple-instance learning (MIL) classifier.

The system may be further caused to: rank each of the plurality of instances based on the determined IIS; and evenly interleave each of the plurality of instances into one of the plurality of pseudo bags based on the rank of each of the plurality of instances.

The system may be further caused to increase a number of the plurality of pseudo bags during a subsequent training iteration on a condition that the MIL classifier converges.

The system may be further caused to freeze the weights of the MIL classifier when determining the IIS for each of the plurality of instances.

According to another embodiment, there is provided a system for classifying a tissue specimen. The system includes a processor module; and a memory module including computer program code. The memory module and the computer program code are configured to, with the processor module, cause the system at least to: (i) extract a plurality of instances from a whole-slide image (WSI) of the tissue specimen; and (ii) input each of the plurality of instances to a multiple-instance learning (MIL) classifier to determine a pathology classification of the tissue specimen.

The MIL classifier is trained by a training corpus comprising a training WSI. Training the MIL classifier includes: extracting a plurality of training instances from the training WSI; determining an Instance Importance Score (IIS) for each of the plurality of training instances, wherein the IIS is determined based on Shapley Value scoring, and wherein the Shapley Value scoring is based on a contribution of each of the plurality of training instances; and assigning each of the plurality of training instances to one of a plurality of pseudo bags based on the determined IIS.

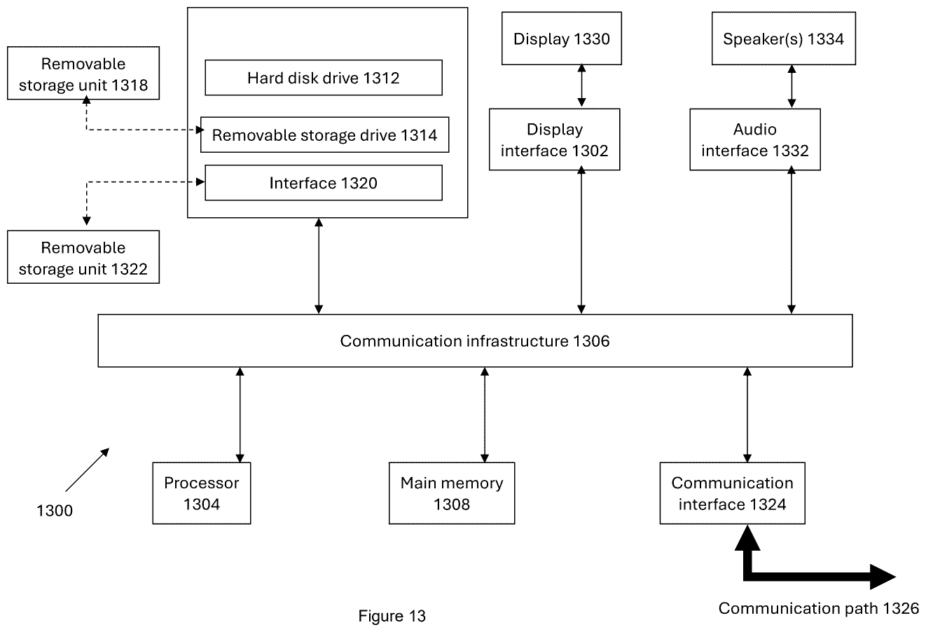

FIG. 13 depicts an exemplary computing device 1300, hereinafter interchangeably referred to as a computer system 1300, where one or more such computing devices 1300 may be to execute/perform methods/steps described herein, such as classifying a whole-slide image (WSI), classifying a tissue specimen, and training a MIL classifier. The following description of the computing device 1300 is provided by way of example only and is not intended to be limiting.

As shown in FIG. 13, the example computing device 1300 includes a processor 1304 for executing software routines. Although a single processor is shown for the sake of clarity, the computing device 1300 may also include a multi-processor system. The processor 1304 is connected to a communication infrastructure 1306 for communication with other components of the computing device 1300. The communication infrastructure 1306 may include, for example, a communications bus, cross-bar, or network.

The computing device 1300 further includes a main memory 1308, such as a random access memory (RAM), and a secondary memory 1310. The secondary memory 1310 may include, for example, a hard disk drive 1312 and/or a removable storage drive 1314, which may include a floppy disk drive, a magnetic tape drive, an optical disk drive, or the like. The removable storage drive 1314 reads from and/or writes to a removable storage unit 1318 in a well-known manner. The removable storage unit 1318 may include a floppy disk, magnetic tape, optical disk, or the like, which is read by and written to by removable storage drive 1314. As will be appreciated by persons skilled in the relevant art(s), the removable storage unit 1318 includes a computer readable storage medium having stored therein computer executable program code instructions and/or data.

In an alternative implementation, the secondary memory 1310 may additionally or alternatively include other similar means for allowing computer programs or other instructions to be loaded into the computing device 1300. Such means can include, for example, a removable storage unit 1322 and an interface 1320. Examples of a removable storage unit 1322 and interface 1320 include a program cartridge and cartridge interface (such as that found in video game console devices), a removable memory chip (such as an EPROM or PROM) and associated socket, and other removable storage units 1322 and interfaces 1320 which allow software and data to be transferred from the removable storage unit 1322 to the computer system 1300.

The computing device 1300 also includes at least one communication interface 1324. The communication interface 1324 allows software and data to be transferred between computing device 1300 and external devices via a communication path 1326. In various embodiments of the inventions, the communication interface 1324 permits data to be transferred between the computing device 1300 and a data communication network, such as a public data or private data communication network. The communication interface 1324 may be used to exchange data between different computing devices 1300 which such computing devices 1300 form part an interconnected computer network. Examples of a communication interface 1324 can include a modem, a network interface (such as an Ethernet card), a communication port, an antenna with associated circuitry and the like. The communication interface 1324 may be wired or may be wireless. Software and data transferred via the communication interface 1324 are in the form of signals which can be electronic, electromagnetic, optical or other signals capable of being received by communication interface 1324. These signals are provided to the communication interface via the communication path 1326.

As shown in FIG. 13, the computing device 1300 further includes a display interface 1302 which performs operations for rendering images to an associated display 1330 and an audio interface 1332 for performing operations for playing audio content via associated speaker(s) 1334.

As used herein, the term “computer program product” may refer, in part, to removable storage unit 1318, removable storage unit 1322, a hard disk installed in hard disk drive 1312, or a carrier wave carrying software over communication path 1326 (wireless link or cable) to communication interface 1324. Computer readable storage media refers to any non-transitory tangible storage medium that provides recorded instructions and/or data to the computing device 1300 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 1300. Examples of transitory or non-tangible computer readable transmission media that may also participate in the provision of software, application programs, instructions and/or data to the computing device 1300 include radio or infra-red transmission channels as well as a network connection to another computer or networked device, and the Internet or Intranets including e-mail transmissions and information recorded on Websites and the like.

The computer programs (also called computer program code) are stored in main memory 1308 and/or secondary memory 1310. Computer programs can also be received via the communication interface 1324. Such computer programs, when executed, enable the computing device 1300 to perform one or more features of embodiments discussed herein. In various embodiments, the computer programs, when executed, enable the processor 1304 to perform features of the above-described embodiments. Accordingly, such computer programs represent controllers of the computer system 1300.

Software may be stored in a computer program product and loaded into the computing device 1300 using the removable storage drive 1314, the hard disk drive 1312, or the interface 1320. Alternatively, the computer program product may be downloaded to the computer system 1300 over the communications path 1326. The software, when executed by the processor 1304, causes the computing device 1300 to perform functions of embodiments described herein.

It is to be understood that the embodiment of FIG. 13 is presented merely by way of example. Therefore, in some embodiments one or more features of the computing device 1300 may be omitted. Also, in some embodiments, one or more features of the computing device 1300 may be combined together. Additionally, in some embodiments, one or more features of the computing device 1300 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

What is claimed is:

1. A computer-implemented method for classifying a whole-slide image (WSI), comprising:
extracting a plurality of instances from a WSI;
determining an Instance Importance Score (IIS) for each of the plurality of instances, wherein the IIS is determined based on Shapley Value scoring, and wherein the Shapley Value scoring is based on a contribution of each of the plurality of instances;
assigning each of the plurality of instances to one of a plurality of pseudo bags based on the determined IIS; and
inputting each of the plurality of instances that are assigned to one of the plurality of pseudo bags to a multiple-instance learning (MIL) classifier.

2. The method of claim 1, wherein assigning each of the plurality of instances to one of the plurality of pseudo bags based on the determined IIS comprises:
ranking each of the plurality of instances based on the determined IIS; and
evenly interleaving each of the plurality of instances into one of the plurality of pseudo bags based on the rank of each of the plurality of instances.

3. The method of claim 1, further comprising increasing a number of the plurality of pseudo bags during a subsequent training iteration on a condition that the MIL classifier converges.

4. The method of claim 3, further comprising freezing the weights of the MIL classifier when determining the IIS for each of the plurality of instances.

5. A computer-implemented method of classifying a tissue specimen, the method comprising:
extracting a plurality of instances from a whole-slide image (WSI) of the tissue specimen; and
inputting each of the plurality of instances to a multiple-instance learning (MIL) classifier to determine a pathology classification of the tissue specimen,
wherein the MIL classifier is trained by a training corpus comprising a training WSI, and wherein training the MIL classifier comprises:
extracting a plurality of training instances from the training WSI;
determining an Instance Importance Score (IIS) for each of the plurality of training instances, wherein the IIS is determined based on Shapley Value scoring, and wherein the Shapley Value scoring is based on a contribution of each of the plurality of training instances; and
assigning each of the plurality of training instances to one of a plurality of pseudo bags based on the determined IIS.

6. The method of claim 5, wherein assigning each of the plurality of training instances to one of the plurality of pseudo bags based on the determined IIS comprises:
ranking each of the plurality of training instances based on the determined IIS; and
evenly interleaving each of the plurality of training instances into one of the plurality of pseudo bags based on the rank of each of the plurality of training instances.

7. A system for classifying a whole-slide image (WSI), comprising:
a processor module; and
a memory module including computer program code;
the memory module and the computer program code configured to, with the processor module, cause the system at least to:
extract a plurality of instances from a WSI;
determine an Instance Importance Score (IIS) for each of the plurality of instances, wherein the IIS is determined based on Shapley Value scoring, and wherein the Shapley Value scoring is based on a contribution of each of the plurality of instances;
assign each of the plurality of instances to one of a plurality of pseudo bags based on the determined IIS; and
input each of the plurality of instances that are assigned to one of the plurality of pseudo bags to a multiple-instance learning (MIL) classifier.

8. The system of claim 7, wherein the system is further caused to:
rank each of the plurality of instances based on the determined IIS; and
evenly interleave each of the plurality of instances into one of the plurality of pseudo bags based on the rank of each of the plurality of instances.

9. The system of claim 7, wherein the system is further caused to increase a number of the plurality of pseudo bags during a subsequent training iteration on a condition that the MIL classifier converges.

10. The system of claim 9, wherein the system is further caused to freeze the weights of the MIL classifier when determining the IIS for each of the plurality of instances.

11. A system for classifying a tissue specimen, comprising:
a processor module; and
a memory module including computer program code;
the memory module and the computer program code configured to, with the processor module, cause the system at least to:
extract a plurality of instances from a whole-slide image (WSI) of the tissue specimen; and
input each of the plurality of instances to a multiple-instance learning (MIL) classifier to determine a pathology classification of the tissue specimen,
wherein the MIL classifier is trained by a training corpus comprising a training WSI, and wherein training the MIL classifier comprises:
extracting a plurality of training instances from the training WSI;
determining an Instance Importance Score (IIS) for each of the plurality of training instances, wherein the IIS is determined based on Shapley Value scoring, and wherein the Shapley Value scoring is based on a contribution of each of the plurality of training instances; and
assigning each of the plurality of training instances to one of a plurality of pseudo bags based on the determined IIS.
